(19) United States
(12) Patent Application Publication
(10) Pub. No.: US 2006/0008550 A1
(43) Pub. Date: Jan. 12, 2006

(54) Gas internal-pressure plastic injection device

(75) Inventor: Gerhard Haspel, Plattling (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/174,902

(22) Filed: Jul. 5, 2005

(30) Foreign Application Priority Data
Jul. 6, 2004 (DE) 20 2004 010 603.5

(51) Int. Cl. B29C 35/08

(52) U.S. Cl. 425/149

(57) ABSTRACT

A gas internal-pressure plastic injection device (1) with a mould cavity (2), to which plastic moulding material can be fed via at least one dosing device (3). An injection device (6) is connected to the interior (4) of the mould cavity (2) via at least one entry point (5) for the controlled supply of pressurised fluid and for injecting the pressurised fluid into the plastic moulding material and an evaluation and control device (7). At least one pressure sensor (8, 9) is assigned to the interior (4) of the mould cavity (2) for the measurement of the internal pressure and, at least from the time of attaining a specified pressure in the pressurised fluid, for the control of the same.

The invention relates to a gas internal-pressure plastic injection device with a mould cavity, to which moulding material can be fed via at least one dosing device, with an injection device joined to the interior of the mould cavity via at least one entry point for the controlled pressurised fluid supply and for blowing in the pressurised fluid into the moulding material and with an evaluation and control device.

Such a device, as known for example from U.S. Pat. No. 5,639,405, is used after the actual injection moulding process in which the moulding material has been charged in the mould cavity using the dosing device to then produce a remaining cavity space by means of a pressurised fluid fed through the injection device in the finally manufactured moulded part. Here, an appropriate pressure is maintained in the pressurised fluid during the setting of the moulded material in the mould cavity for pressing the moulding material onto the internal wall of the mould cavity and thus to establish an outer contour of the finished moulded part.

Using the evaluation and control device, in this connection at least the injection device and therefore the pressurised fluid supply is monitored and optionally controlled.

Using such a gas internal-pressure plastic injection device, various parts for the automotive industry, plastic consumer articles, etc. can be produced. Essentially, all thermoplastic materials with or without fibre content can be processed.

In contrast to other plastic injection devices there are various advantages, such as for example, savings in weight and material, time savings due to cycle time reduction, increased stiffness, good surface quality, less distortion and less residual stresses in the finished moulded part, etc.

In U.S. Pat. No. 5,639,405 the gas internal-pressure plastic injection device exhibits at least one sensor in the interior of the mould cavity. Such a sensor is generally a temperature sensor. With this sensor it is possible to find out when the moulding material, which is fed by the dosing device to the mould cavity, reaches a certain point within the mould cavity. Here, the sensor determines the temperature within the mould cavity at a certain time point and compares it with a previously determined temperature. If the temperature changes by more than a specified amount, the feed of the moulding material through the dosing device is terminated and the injection device for supplying the pressurised fluid is operated. Then moulding material is pressed against the internal wall of the mould cavity and the pressure is maintained by the pressurised fluid until the moulding material has cooled sufficiently to be self-supporting. Then the pressurised fluid is removed and finally the finished moulded part can be taken out.

A disadvantage with this known state of the art is that no direct control of the pressure in the pressurised fluid occurs after the mould cavity has been sufficiently filled. Instead, only pre-programmed instructions with regard to the fluid pressure are saved in the respective evaluation and control device and are called after the pressurised fluid feed has been initiated and are used for controlling the fluid pressure. However, it is not possible to find out optionally at other points in time during the feed of the pressurised fluid and the following stages whether the pressure present is already sufficient, whether optionally more pressurised fluid must be fed to increase the pressure and whether a desired maximum pressure, for example for post-pressurisation within the mould cavity or for adequate pressing of the moulding material onto the internal wall of the mould cavity is present. Such an adequate and correctly adjusted maximum pressure is however important particularly for the surface quality of the manufactured moulded part.

The object of the invention is therefore to improve a gas internal-pressure plastic injection device of the type stated in the introduction such that monitoring and control of the fluid pressure at least during a certain time period within the mould cavity is possible with simple constructive means.

This object is solved by the features of claim 1.

According to the invention at least one pressure transducer or sensor is arranged inside the mould cavity. The pressure is measured and, at least after reaching a specified fluid pressure, controlled by this pressure transducer. As a result, at least the pressure increase/reduction in the fluid is controlled from the specified fluid pressure. This ensures that an adequate amount of pressurised fluid is injected into the moulding material with a suitable pressure so that the material is pressed against the internal wall of the moulded cavity, without, for example, the pressurised fluid penetrating the moulded material. At the same time it is possible to increase the fluid pressure at any time if later pressurising is necessary within the mould cavity. Also the appropriate retention and maximum pressure in the pressurised fluid can be correctly determined in order to press the moulding material against the internal wall of the mould cavity with sufficient pressure and to achieve a good surface quality of the finished moulded part. In addition, the fall in pressure can be monitored and controlled. There is also the possibility of measuring and controlling the respective pressure already during the complete feed of the pressurised fluid and optionally also of determining the time at which the pressurised fluid is fed and of triggering the fluid feed.

In a simple embodiment of the arrangement of the pressure transducer, it can be positioned inside or in a wall of the mould cavity. This arrangement can occur favourably opposite the entry point of the injection device. The pressure transducer measures the pressure with which the moulding material is pressed against the wall.

There is the possibility that the feed of the pressurised fluid occurs at least partially via the same feed devices as the moulding material, so that no separate entry point is required for feeding the pressurised fluid. However, in order not to influence the pressure for the moulding material built up in the dosing device by feeding the pressurised fluid using the injection device and to be able to maintain a continuous connection of the moulding material within the mould cavity with further moulding material in the dosing device or in a feed device connecting to it, the entry point can be arranged separate to a corresponding discharge opening of the dosing device. Of course, in this connection, there is also the possibility of feeding the pressurised fluid over a number of appropriately arranged entry points to the mould cavity.

In order to ensure where possible in a simple manner that the pressurised fluid is pressed inside the moulding material and no penetration of the moulding material occurs, the entry point or points can be arranged adjacent to the discharge opening. In this respect it should be noted that, for example, there is the possibility that the mould cavity is only partly filled with the moulding material, before the pressurised fluid is fed in. In this case the appropriate arrangement of the entry point in the vicinity of the discharge opening is particularly favourable.

In order to be able to use the pressure transducer in a simple manner directly for the control of further parameters of the device, it can be connected to the evaluation and control device. There is also the possibility that the pressure transducer is only connected, for example, to a display device and the respective pressure values are displayed. Depending on the pressure value present, an appropriate adjustment, for example in the pressurised fluid supply, can be made manually using the evaluation and control device. However, an automatic adjustment is more favourable in this respect, in that the evaluation and control device directly receives the appropriate pressure values and reacts to them.

In order to be able to optionally simply replace the pressure transducer, it can be arranged directly in a wall of the mould cavity, in particular releasably. Appropriate openings in the wall can be provided at different points for a number of pressure transducers. These openings can be closed off by covers or similar devices if no pressure transducer is required at these points.

In order to be able to vary the pressure in the pressurized fluid quickly in a simple manner according to the requirements, the injection device can be connected to a compressor device, in particular with pre- and post-compressors.

Depending on the plastic material used, its composition with, optionally, fibres or a similar additive, the temperature of the plastic, etc., there is the possibility that a different trace of the pressure of the moulding material against the wall is of advantage during the manufacture of the appropriate moulded part. Such a trace can be determined experimentally as a pressure profile or also theoretically. According to the invention, such a pressure profile for the moulding material and /or for the pressurised fluid can be selected and/or modified. Changes in the pressure profile also arise due to changes in the design of the moulded part which are produced by corresponding structural changes on the internal wall of the moulded cavity.

Appropriate monitoring of the pressure in the moulding material and indirectly in the pressurised fluid is then also particularly of advantage when the gas internal-pressure plastic injection device exhibits a secondary cavity which is connected to the mould cavity via at least one connection opening in it. In such a case, generally the mould cavity is filled with the moulding material and then a still plastic internal region of the moulding material is blown out into the secondary cavity by the pressurised fluid. In this connection, an appropriate control of the fluid pressure using the pressure transducer is particularly of advantage, because both the amount of the blown-out moulding material and the blow-out speed can be influenced by the pressure of the pressurised fluid.

According to the invention, in this connection it can also be established by the pressure transducer from when such a blow-out into the secondary cavity can occur. In order to initiate the blow out in this conjunction, an adjustable flow control device can be assigned to a connecting pipe between the connection opening and the secondary cavity or to the connection opening itself. Through this flow control device, the start of the blow-out can on one hand be defined by appropriate opening and on the other hand, depending on the opening of the flow control device, both the pressure in the pressurised fluid or in the moulding material as well as the quantity of the blown-out moulding material can be determined.

A simple construction for blowing out into the mould cavity can be provided in an advantageous manner if the connection opening is arranged relative to the mould cavity opposite the discharge opening. This is particularly advantageous in conjunction with the arrangement of the entry point for the injection device adjacent to the discharge opening.

In order to be able to find out using the pressure transducer, for example, whether the mould cavity is sufficiently filled with moulding material, such a pressure transducer can be arranged adjacent to the connection opening and/or in the connecting pipe. The appropriate arrangement of the pressure transducer is in this conjunction dependent on the flow control device, which establishes or interrupts the connection between the mould cavity and the secondary cavity. Here, the appropriate pressure transducer should be arranged on the side of the mould cavity with respect to the flow control device.

In order to measure the pressure at different points within the mould cavity and/or secondary cavity, optionally in the connecting pipe or also in the secondary cavity, two or more pressure sensors can be used. For a more precise measurement of the pressure in the moulding material or for the indirect measurement of the pressure in the pressurised fluid and also for reasons of redundancy, two such pressure sensors can be arranged essentially opposite one another relative to the connection opening and closely adjacent to it. In this connection, it again applies that the appropriate pressure sensors are arranged on the mould cavity side with respect to the flow control device. Also here there is the possibility that at least one further pressure sensor is assigned to the connecting pipe between the mould cavity and the secondary cavity or also to the secondary cavity itself.

According to the invention, there is the possibility that the flow control device is controlled in dependence of the measurements of the pressure transducer or transducers from the evaluation and control device. Such a control occurs on one hand for opening the flow control device and also for blowing out the moulding material in the direction of the secondary cavity.

The flow control device can also be closed by the evaluation and control device, before, for example, the fluid pressure within the mould cavity falls or the finished moulded part is removed from the mould cavity. Through the closure of the flow control device the finished moulded part can also be separated from the material blown out into the secondary cavity.

It can also be regarded as favourable if the entry of the pressurised fluid and/or pressurised fluid post-pressures and/or the opening or closure of the secondary cavity within particularly selectable and specifiable pressure windows can be controlled from the evaluation and control device.

With such pressure windows a certain margin is specified in which the appropriate control of the entry of the pressurised fluid, pressurised fluid post-pressures and similar parameters occurs.

In the following an advantageous embodiment of the invention is explained based on the figures given in the drawing.

The following are shown:

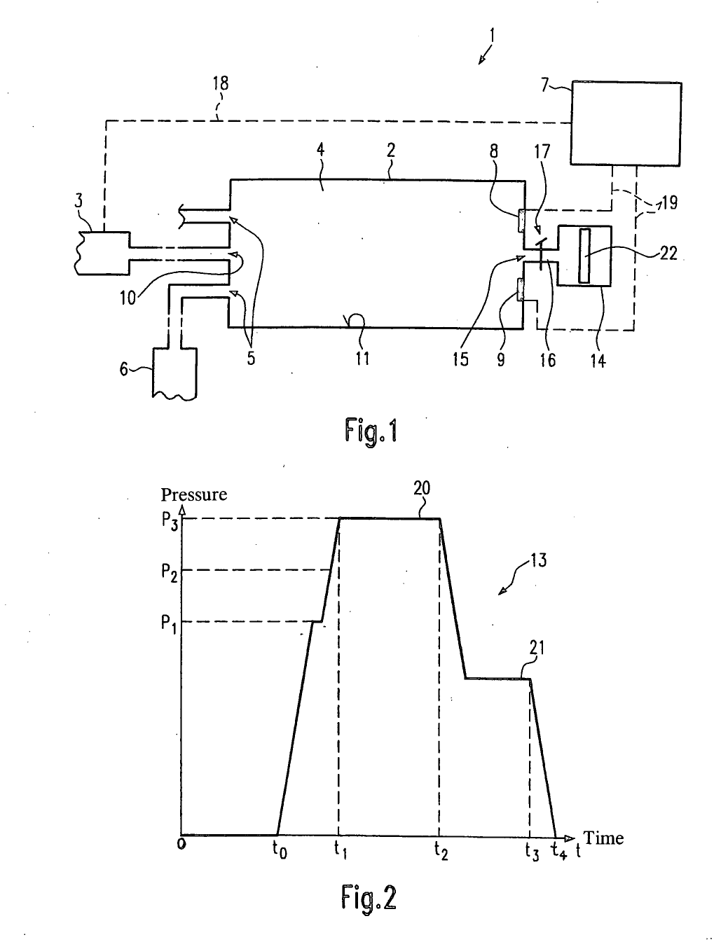

FIG. 1 a partially sectioned view of a gas internal-pressure plastic injection device according to the invention and

FIG. 2 a graph of the temporal pressure dependence in a mould cavity for the device according to FIG. 1.

FIG. 1 illustrates an embodiment of a gas internal-pressure plastic injection device 1, wherein at least the mould cavity 2 and the secondary cavity 14 are shown in section.

The mould cavity 2 is used for moulding the respective moulded part, wherein the walls 11 are structured appropriately. For the sake of simplification this structure is not illustrated in FIG. 1.

The mould cavity 2 is connected to a dosing device 3 with the aid of which a plastic synthetic moulding material can be pressed into the interior 4 of the mould cavity 2 via a discharge opening 10. Such a dosing device 3 can, for example, be equipped with an extruder or similar device for plasticising the plastic material and for conveyance in the direction of the mould cavity.

Two entry points 5 are arranged closely adjacent to the discharge opening 10. Through these a pressurised fluid can be forced into the interior 4 of the mould cavity 2 using an injection device 6. In doing this, this pressurised fluid is injected into the moulding material that has already been charged in order to form a cavity space by displacing a certain part of the moulding material. After the formation of the hollow part and cooling, the pressurised fluid can be recovered via the injection device 6 or also at another point of the mould cavity 2.

The mould cavity 2 exhibits a connection opening 15 essentially opposite the discharge opening 10. Through this opening, the mould cavity 2 is connected to a secondary cavity 14. There is the possibility of connecting the secondary cavity 14 directly to the connection opening 15.

In the illustrated embodiment a connecting pipe 16 extends between the connection opening 15 and the secondary cavity 14. A flow control device 17 is assigned to the said pipe or also directly to the connection opening 15.

In the illustrated embodiment a piston 22 is supported for displacement within the mould cavity 2. The said piston is displaced within the secondary cavity 14 by the moulding material forced out of the mould cavity 2.

Two pressure sensors 8, 9 are arranged closely adjacent to the connection opening 15. These are assigned to the interior 4 of the mould cavity 2 and can, for example, be arranged in the respective wall 11. Generally, the arrangement is such that the pressure transducers do not protrude in the direction of the interior 4 of the mould cavity 2 so as not to affect in any way the formation of an appropriate surface of the moulded part to be produced.

The gas internal-pressure plastic injection device 1 exhibits an evaluation and control device 7. It is connected via appropriate electrical connecting leads 18, 19 to the various parts of the device 1 to be controlled. For example, a connection to the dosing device 3 occurs via the electrical connecting leads 18. As a result, the feed of the moulding material to the mould cavity 2 can be monitored and optionally controlled in addition to the actual machine control. An appropriate connection, which is not shown, is also provided to the injection device 6 to control the feed of the pressurised fluid. Appropriate signals from each of the pressure transducers 8, 9 can be received via the electrical connecting lead 19.

Further electrical connecting leads can be connected to further pressure transducers, which are not illustrated, and to the flow control device 17.

Such further pressure transducers can also be provided in the connecting pipe 16 or also in the secondary cavity 14 as well as at other points in the mould cavity 2.

The fed moulding material is a thermoplastic material, which can also be processed with or without a fibre content. Examples of such thermoplastic materials are ABS (acrylonitrile butadiene styrene), PA (polyamide), PC (polycarbonate), PP (polypropylene), PS (polystyrene), PE (polyethylene) or similar compounds.

The pressurised fluid can be both gaseous or liquid. With a gaseous pressurised fluid it is generally an inert gas such as N₂, CO₂ or similar. This applies analogously also to a corresponding liquid pressurised fluid.

In FIG. 2 an example of a pressure profile 13 is illustrated, which shows the temporal dependence of the pressure within the mould cavity 2 and acquired by at least one of the pressure transducers 8, 9. The moulding material is pressed onto the pressure transducer with this pressure.

At time “0” moulding material is fed in by the dosing device 3. From time t₀ so much moulding material is present within the mould cavity 2 that the pressure transducers 8, 9 positioned opposite the discharge opening 10 measure an increase in the pressure. At pressure p₁ the injection device 6 is driven for feeding the pressurised fluid, i.e. from this pressure or from the corresponding point in time the feed of pressurised fluid to the moulding material occurs which has already been charged into the mould cavity 2. Up to a higher pressure value p₂ the pressure within the mould cavity is generally increased by the pressurised fluid without further feed of moulding material until the respective moulding material closely contacts the internal wall 11 of the mould cavity. In this way it is ensured that the finished moulded part is later given the desired surface structure. A partial cooling of the moulding material coming into contact with the inner wall occurs already due to this close contact with the inner wall of the mould cavity 2. On attaining the pressure p₂, which may be a specified pressure value, the pressure control occurs using the pressure transducer, the pressure in turn being measured by the respective pressure transducers 8, 9 and a drive of the flow control device 17 by the evaluation and control device 7 occurs for opening the connection opening 15 and the connecting pipe 16. Through further increase in the pressure up to a maximum pressure value p₃, displacement or blowing out of the still plastic, internal moulding material occurs in the direction of the secondary cavity 14 due to the pressurised fluid. By displacement of the respective piston 22, the amount of the displaced moulding material, which is finally positioned in the secondary cavity 14 and optionally in the connecting pipe 16, can be determined. The maximum pressure value p₃ is maintained for a period from t₁ to t₂, see plateau 20, wherein, during this time period and in part also already after attaining the pressure value p₂, the respective amount of the moulding material is displaced from the mould cavity 2 by the pressurised fluid to obtain a hollow moulded part.

From time t₂ the pressure in the fluid is reduced by means of the evaluation and control device 7 and due to corresponding pressure values in the moulding material acquired by the pressure transducers 8, 9, because no further displacement of moulding material is required in the direction of the secondary cavity 14. However, the pressure is only reduced to a certain retaining pressure, see plateau 21 in FIG. 2, wherein this retaining pressure ensures that close contact continues to exist between the moulding material and the internal wall of the mould cavity 2 and, for example, no vibrations or similar effects occur on the moulded part. The pressure plateau 21 is generally maintained until the complete setting of the moulding material, see time t₃, and then complete reduction of the pressure in the pressurised fluid occurs, wherein the fluid can be recovered. At time t₄ the pressurised fluid is removed and the moulding material no longer presses on the pressure transducer and at this point in time or at a later point in time the mould cavity can be opened for the removal of the finished moulded part.

According to the invention, control of the complete cycle for the manufacture of the moulded part takes place based on the pressure values acquired by the pressure transducers 8, 9. This applies at least for the pressure profile 13 according to FIG. 2 between times t₀ and t₄. In addition it can also be found by means of the pressure transducers 8, 9 whether the finished moulded part is released from the internal wall 11 of the mould cavity 2.

1. A gas internal-pressure plastic injection device (1) with a mould cavity (2), to which plastic moulding material can be fed via at least one dosing device (3), an injection device (6) connected to the interior (4) of the mould cavity (2) via at least one entry point (5) for the controlled supply of pressurised fluid and for injecting the pressurised fluid into the plastic moulding material and an evaluation and control device (7), wherein at least one pressure sensor (8, 9) is assigned to the interior (4) of the mould cavity (2) for the measurement of the internal pressure and, at least from the time. of attaining a specified pressure in the pressurised fluid, for the control of the same.

2. A gas internal-pressure plastic injection device according to claim 1, wherein the pressure sensor (8, 9) is arranged essentially opposite the entry point (5) of the injection device (6).

3. A gas internal-pressure plastic injection device according to claim 1, wherein the entry point (5) is arranged separately to a discharge opening (10) of the dosing device (3).

4. A gas internal-pressure plastic injection device according to claim 1, wherein the entry point (5) is arranged adjacent to the discharge opening (10).

5. A gas internal-pressure plastic injection device according to claim 1, wherein the pressure sensor (8, 9) is connected to the evaluation and control device (7).

6. A gas internal-pressure plastic injection device according to claim 1, wherein the pressure sensor (8, 9) is arranged in the interior (4) of the mould cavity (2) and in particular in a wall (11) of the mould cavity (2).

7. A gas internal-pressure plastic injection device according to claim 1, wherein the injection device (6) exhibits a compressor device with in particular pre- and post-compressors.

8. A gas internal-pressure plastic injection device according to claim 1, wherein a pressure profile (13) can be selected and/or modified for the moulding material and/or for the pressurised fluid.

9. A gas internal-pressure plastic injection device according to claim 1, wherein a secondary cavity (14) is connected to the mould cavity (2) via at least one connection opening (15).

10. A gas internal-pressure plastic injection device according to claim 1, wherein an adjustable flow control device (17) is assigned to a connecting pipe (16) between the connection opening (15) and the secondary cavity (14) or the connection opening (15) itself.

11. A gas internal-pressure plastic injection device according to claim 1, wherein the connection opening (15) is arranged relative to the mould cavity (2) essentially opposite the discharge opening (10).

12. A gas internal-pressure plastic injection device according to claim 1, wherein the pressure sensor (8, 9) is arranged adjacent to the connection opening (15) and/or in the connecting pipe (16).

13. A gas internal-pressure plastic injection device according to claim 1, wherein two pressure sensors (8, 9) are arranged relative to the connection opening (15) essentially opposite one another and adjacent to the said opening.

14. A gas internal-pressure plastic injection device according to claim 1, wherein the flow control device (17) can be controlled in dependence of measurements of the pressure sensors (8, 9) from the evaluation and control device (7).

15. Gas internal-pressure plastic injection device according to claim 1, wherein the entry of the pressurised fluid and/or the pressurised fluid post-pressures and/or opening/closure of the secondary cavity (4) can be controlled within especially selectable and specifiable pressure windows from the evaluation and control device (7).
